(19) United States
(12) Patent Application Publication
(10) Pub. No.: US 2017/0099144 A1
(43) Pub. Date: Apr. 6, 2017

(54) EMBEDDED ENCRYPTION PLATFORM COMPRISING AN ALGORITHMICALLY FLEXIBLE MULTIPLE PARAMETER ENCRYPTION SYSTEM

(71) Applicant: PREM SOBEL, AUSTIN, TX (US)

(72) Inventor: PREM SOBEL, AUSTIN, TX (US)

(21) Appl. No.: 14/876,670

(22) Filed: Oct. 6, 2015

(51) Int. Cl. H04L 9/32; H04L 9/08; H04L 29/06

(52) U.S. Cl. CPC H04L 9/3226; H04L 9/3271; H04L 63/08; H04L 63/083; H04L 9/0863

(57) ABSTRACT

A machine-to-machine (M2M) partner automates all program parameter calculations through scripting or programming during an end-to-end encryption and decryption process. A platform dynamically scripts or programs the calculation of the encryption parameters and automatic response to alarms and alerts or to protect data transfers. The dynamic scripting effectively causes the same platform to be a different custom version for each value of parameters. Different custom versions of the platform encryption engines are not interoperable with each other or with a standard version. Variable and flexible multi-faceted unpredictable authentication methods authorize communication nodes. The platform performs multiple-stage checking of version, key, and password. The platform controller scrubs memory before exiting. A “Seed Packet” of data is used algorithmically to generate a sequence of random data to both generate and make use of an encryption key and password. The algorithmic process steps are themselves subject to change.

### BACKGROUND

Field

The present subject matter relates to a machine-to-machine smart encryption platform for dynamically scripted or programmed calculation of encryption parameters and automatic response to alarms and alerts, and to encrypt data transfers and software updates and multi-factor authentication.

Related Art

The need to secure against cyber-crime, which has grown to have a multi-billion dollar economic impact, is extreme. There are currently recognized encryption key mechanisms such as Public Key Infrastructure (PKI) and currently supported standard key establishment and communications mechanisms or protocols recommended by the federal government, particularly the National Institute of Standards and Technology (NIST). Due to the continually evolving sophistication of attackers, there have been a large number of successful attacks against facilities using the published mechanisms and protocols. Many commonly relied-upon protocols do not have sufficient unpredictability to stand up to increasing sophistication and computing power of hackers.

The need to expose encrypted data is further exacerbated by Cloud computing. Cloud computing is a convenient, cost-effective practice in which servers and storage are utilized that are outside of a user's network.

Sensitive data, such as medical records, trade secrets, and financial reports, are stored in the Cloud. However, as a practical matter, data must be stored in the Cloud in encrypted form. Additional steps must be taken because data is not readily able to be processed in the Cloud. A best practice has been developed of encrypting data to be sent to the Cloud. In order to view, modify, or process data, the user retrieves the data from the Cloud, decrypts it, views or manipulates the data, re-encrypts it, and sends it back to the Cloud. This practice requires users to forego many of the benefits they seek through use of the Cloud. One such benefit is the ability to send data to the Cloud for processing with software-as-a-service (SaaS) resources.

Another significant issue is authentication. Current systems provide a limited number of parameters on which to base authentication and a limited number of possible values for the authentication parameters.

It is also difficult to provide encryption for data being put into a flash drive and then decrypt the data at a different physical location where it is downloaded.

United States Published Patent Application No. 20140068254 discloses a web-based platform for collaborating on projects or jointly working on documents that can be used by individual users and shared among collaborators. This is an example of the system described above in which a user must retrieve the data from the Cloud, decrypt it, view or manipulate the data, re-encrypt it, and send it back to the Cloud. The benefit of using data within the Cloud is not provided.

United States Published Patent Application No. 20130108040 discloses an identity based encryption platform. Computation closures include data, information, and computation elements. Key generation is, at least in part, based on a segmentation of a computation closure into at least a first part and one or more second parts and an encryption of the one or more second parts using the first part as a public key of an identity-based encryption. Unpredictability is not enhanced.

United States Published Patent Application No. 20130061037 discloses encrypted communications in which a same encryption key is used for a first application, i.e., a device that obtains data collected by a terminal or that controls a terminal, and for a terminal which is only bound to the first application. Information is transparently transmitted between the terminal and the first application when determining that the terminal communicates with the first application by using the same encryption key. The range of encryption parameters and values is limited.

United States Published Patent Application No. 20110302358 discloses a multi-channel flash system that supports security. A mapping structure is desirable to map logical addresses to physical blocks in the flash memory. While multiple channels are provided, multiple encryption paths are not provided.

United States Published Patent Application No. 20130332747 discloses a removable drive such as a USB drive or key provided for connecting to computer devices to provide secure and portable data storage. The drive includes a drive manager adapted to be run by an operating system of the computer device. The drive manager receives a password, generates a random key based on the password, encrypts a user-selected data file in memory of the computer device using the key, and stores the encrypted file in the memory of the removable drive. The drive manager may include an Advanced Encryption Standard (AES) cryptography algorithm. This system is not adapted to use Anti-Statistical Block Encryption (ASBE) encryption, which is far more secure than AES. The drive manager generates a user interface that allows a user to enter passwords, select files for encryption and decryption, and create folders for storing the encrypted files on the removable drive. An image file is used as a basis for key generation. An image provides a limited number of data points.

### SUMMARY

Briefly stated, in accordance with the present subject matter, a machine-to-machine (M2M) partner automates all program parameter calculations through scripting or programming during an end-to-end encryption and decryption process. A scriptable controller invokes the unique functionality of special purpose hardware and software to run programs which will securely control the system, produce and send, or receive and utilize data. A platform can uniquely enable an engineer to dynamically script or program the calculation of the encryption parameters and automatic response to alarms and alerts or to protect data transfers. The dynamic scripting effectively causes the same platform to be a different custom version for each value of parameters. Different custom versions of the platform encryption engines are not interoperable with each other or with a standard version.

The coordination, communications, and sequence of running M2M operation can either be built into the M2M's software by employing a library of application program interfaces (APIs) or a custom program which is designed per specific machine purpose.

Variable and flexible multi-faceted unpredictable authentication methods are provided to authorized communication nodes. Upon decryption, the platform performs multiple-stage checking of version, key, and password. One form of authentication checks program size to detect tampering. The platform controller scrubs memory before exiting.

A data structure called a “Seed Packet” of data is comprised of multiple data sets, or “Seeds.” Each seed is used algorithmically to generate a sequence of random data. A changeable algorithm utilizes one or more seeds to both generate and make use of an encryption key and password. The algorithmic process steps are themselves subject to change. This improves unpredictability of encryption. This arrangement enables speed-optimized, mass-quantity encryption.

In addition to encrypted data, the data stream may also include encrypted directions to command processing of the data once it has safely been transmitted to a memory or file.

In order to authorize a particular set of users to interact with one another, a token is provided to each user in the set to enable response to the dynamic scripting or programming. The token is preferably sent to the authorized users over a communication channel other than the data channel used to send the encrypted data.

### BRIEF DESCRIPTION OF THE DRAWINGS

The present subject matter may be further understood by reference to the following description taken in connection with the following drawings:

FIG. 1 is a block diagram of a communication process in which commands and data are exchanged between a platform and a system providing data and a request for processing;

FIG. 2 is a block diagram of the platform's response to the incoming request;

FIG. 3A is a detailed block diagram of an encryption module;

FIG. 3B is a detailed block diagram of a system before the encryption platform is added for security;

FIG. 3C illustrates processes and data flow in the encryption module of FIGS. 3A and 3B;

FIG. 4 is a block diagram of one form of platform embodying the files and programs in one embodiment of the present subject matter;

FIG. 5 is a diagram of structure of a seed packet;

FIG. 6 is a diagram of one example of a seed structure;

FIG. 7 is an illustration of a seed token;

FIG. 8 is a block diagram of a platform comprising a random data generator and an encryption engine;

FIG. 9 illustrates a generalized authentication scheme;

FIG. 10A is a block diagram of an authentication and communications buffer module within the platform of FIG. 9;

FIG. 10B is a block diagram of validation of data between nodes;

FIG. 11 is a block diagram of a name-value association module for use in various functions such as authentication and data transformation;

FIG. 12 is a block diagram of multiple communication channels between nodes; and

FIG. 13 illustrates a system in which the encryption platform is used to secure data in a portable storage device.

### DETAILED DESCRIPTION

Sophisticated attackers frequently attack infrastructure and other facilities that are controlled and operated by software. Facilities include power plants, transportation systems, and medical records systems. A large number of successful attacks have been made against facilities employing encryption using defined key establishments, storage, and communications methods and protocols which are generally recognized as adequate.

The encryption according to the present subject matter, a machine-to-machine (M2M) partner automates all program parameter calculations through scripting or programming during an end-to-end encryption and decryption process. This technique defeats virtually all key breaking methods since a key is never sent or exposed. The present subject matter addresses the problem of malware and rootkits installing themselves as hypervisors. Anti-malware software cannot be relied upon to detect the malware since the malware runs below the entire operating system. Therefore, the malware could attempt to intercept any operations of the operating system, e.g., entering a password, without the anti-malware software necessarily detecting it.

The present subject matter can avoid the hazard of installed malware by performing all encryption and decryption on a computer that is never connected to the Internet or any other standard communications channel. Encrypted files can be moved from the isolated computer to a computer connected to a communications network. Data may be moved on a flash drive or by a dedicated communications channel that can only move data and has no possible protocol to reach into the secure computer or cause a program or Basic Input/Output System (BIOS) to run. Preferably, the software should be loaded in a secure, guarded, physical pass protected, locked room. The room may be shielded, as by Tempest shielding.

Unpredictability increases security. To increase unpredictability one can rename executable and data files to hide what they really are. It is also possible to use random names and paths created and destroyed as by deleting or shredding after an encryption operation. In another form, a time period can be set at the end of which critical encryption parameters such as a key and a password automatically expire. One example is to include a calculation based on a time factor such as the day of the month in the scripted or programmed algorithm. Alternatively, one can use one or more non-constant stochastic authentication factors in the scripted or programmed algorithm to calculate encryption parameters using a seed set from a seed packet. The authentication inputs may comprise either textual noun name style format or randomly selected variables. Using the state machine it can randomly pick. Response to the authentication inputs comprises a state machine defining transitions of states in response to each input. Authentication inputs are embedded in noise. Authentication may comprise querying a sending device as to its IP address or CPU serial number, for example.

In order to counter vulnerability, the present subject matter provides encryption keys that are virtually unbreakable because they and password are of variable length and change unpredictable to hackers. In this encryption technique, a data structure called a seed packet is used algorithmically to generate a sequence of random data. A changeable algorithm utilizes one or more seeds to both generate and make use of an encryption key and password.

The contents of a seed may be used in its entirety or a sub-sequence of seed data may be used. The length of a sub-sequence of data is specified directly or indirectly, i.e. algorithmically, by data within the seed. The random data sequence is used to generate the encryption key or the encryption password.

The algorithmic process used to generate keys or passwords for input into an encryption engine, increases unpredictability exponentially. The changeable algorithmic process steps are methods that replace either the software in its entirety or in part, and/or a data table used by the software. Also, the software update or the data table can optionally be encrypted itself by yet another encryption key only known to the encryption system. The encryption system comprises a platform. The platform is an application under which the programs implementing the present subject matter operate, or as a software library compiled into the system application software. The platform comprises software development kit (SDK) with an application program interface (API).

The algorithms used by the platform can be scripted using a scripting language such as the MerlinCryption®Wrap Language™, available from MerlinCryption LLC of Austin, Tex., or other scripting language. The algorithms may be embodied by code written in a standard programming language such as C or C++ using the MerlinCryption® Encryption Platform API and static libraries.

Each seed can optionally contain a code number which specifies which algorithm, or algorithmic variation, is applicable for that individual seed. The meaning, or interpretation, of this code number is subject to change at any time by updating the software or data tables. Encryption key generation is used, for example, in the context of secure operation of facilities.

A seed packet is a set of multiple encryption parameters which are used one at a time by a sender and by a receiver of encrypted data. An initial synchronizing command file is created and includes the algorithm to synchronize the sender and the receiver of encrypted data. The algorithm may be quickly changed by a defined process when a trusted holder of the algorithm no longer has a need to know.

Significant elements of the present subject matter include creating and distributing the seed packet, which is a set of multiple encryption parameters to be used, one at a time, by sender and receiver of encrypted data. An initial synchronizing encrypted command file or message is written which contains the algorithm to synchronize sender and receiver of encrypted data. A policy is generated of when and how to update the seed packet and synchronizing the encrypted command files.

This algorithm must be known by only a few trusted employees whose job it is to keep data and operations secure. The algorithm should be unpredictable to possible observers or interceptors of encrypted data or observers of the computer. The algorithm may be quickly changed by a defined process, when a trusted holder of the algorithm no longer has a need to know.

As discussed further below, dynamic authentication factors are provided.

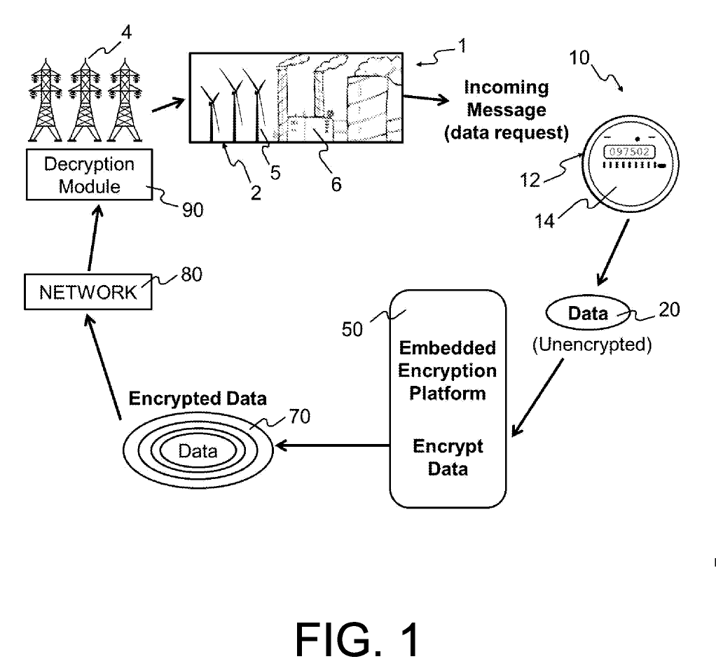

FIG. 1 is a block diagram of a communication process in which commands and data are exchanged between a platform and a system providing data and a request for processing.

A facility 1 in the present embodiment comprises an electric power generating station 2. Facilities 1 will generally include subsystems. In the present embodiment, subsystems of the electric power generating station 2 comprise a distribution system 4, a generator 5, and a control station 6. The facility 1 may request data from a user 10. The user 10 may comprise a household, for example. The user 10 comprises a receiver 12 which receives inquiries from the facility 1. In the present embodiment, the receiver 12 is an electric meter 14. The electric meter 14 receives an inquiry from the facility 1. The inquiry may take many different forms. In one form, the inquiry requests the amount of power being consumed by the user 10. The inquiry is processed in a data module 20. The encryption platform 50 encrypts processed information from the data module 20. Encrypted data 70 is transmitted via a network 80 to the facility 1.

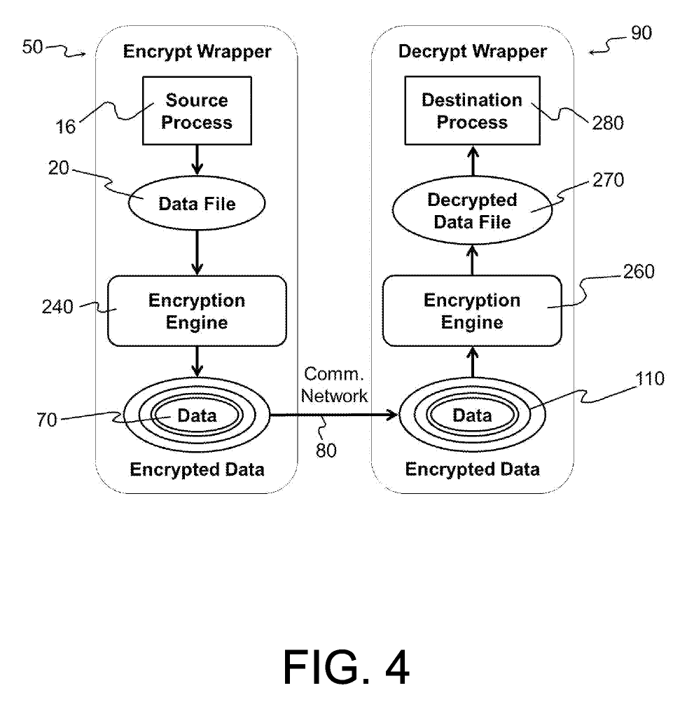

The receiver 12 embodies a source process 16 (FIG. 4). The source process is the transformation of the request from this facility 1 by the receiver 12 which produces the unencrypted data provided to the data module 20.

The encryption utilizes dynamic layers. Unpredictable and uniquely changing keys are provided to counter increasing computer-power and constantly evolving investigative techniques of hackers. The encryption platform protects normal data transfer, software updates, remote control, status queries, problem alerts, and billing/usage information. Encrypted data is received at the facility 1 and decrypted for utilization at a decryption platform 90.

As further explained below, dynamic scripting or programming of encryption parameters is provided. The script or program is able to use external encrypted data files to modify its behavior. These external data files can change at any time as controlled by the master computer. Therefore, an encryption platform at one time executing a particular instruction of an algorithm appears to be one device. A set of authorized users will be using the same algorithm. The authorized users share one version of the platform. Different custom versions of the platform will be seen by other users who have been supplied with other values within their current algorithm. Consequently, different custom versions of the platform encryption engines are not interoperable with other custom versions. Payloads are encrypted and can be transmitted by any communications protocol and on any network. No two encrypted transmissions are alike, even when they are using the same key, password, and data parameters.

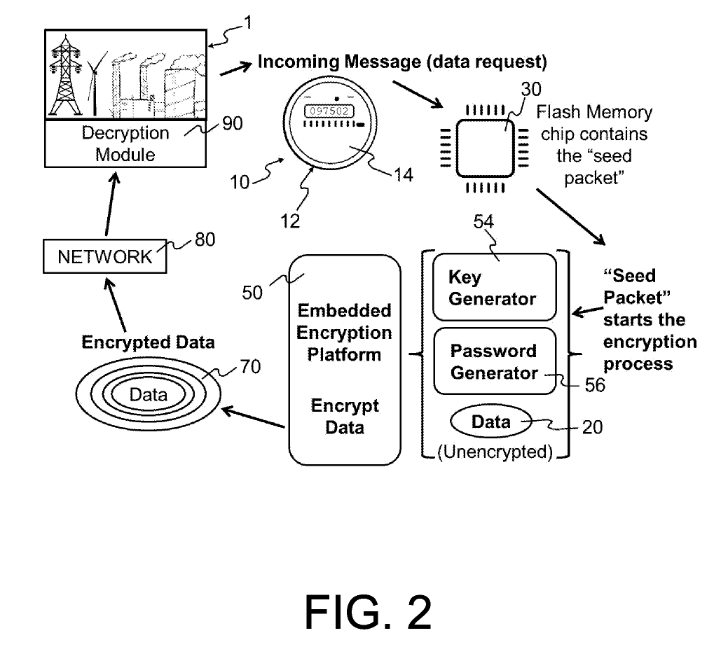

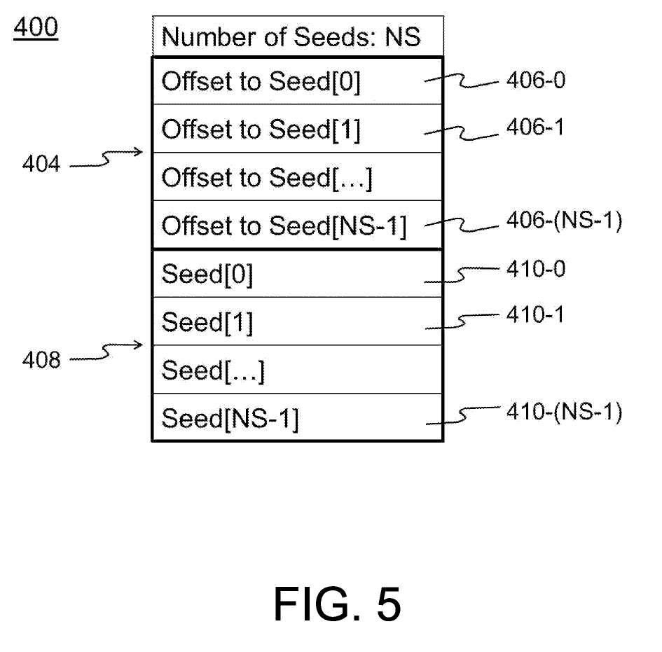

FIG. 2 is a block diagram of the platform's response to the incoming request. The inquiry from the facility 1 is processed in the data module 20. Processing is performed, for example, in a flash memory chip 30. Registers external to the memory chip 30 are not used. Operations are conducted within the memory chip 30. A seed packet 400 (FIG. 5), further described below, is stored in the memory chip 30. The inquiry prompts the memory chip 30 to send a seed from the seed packet to an encryption platform 50. The encryption platform 50 comprises an operating environment under which a key generator 54 and a password generator 56 run.

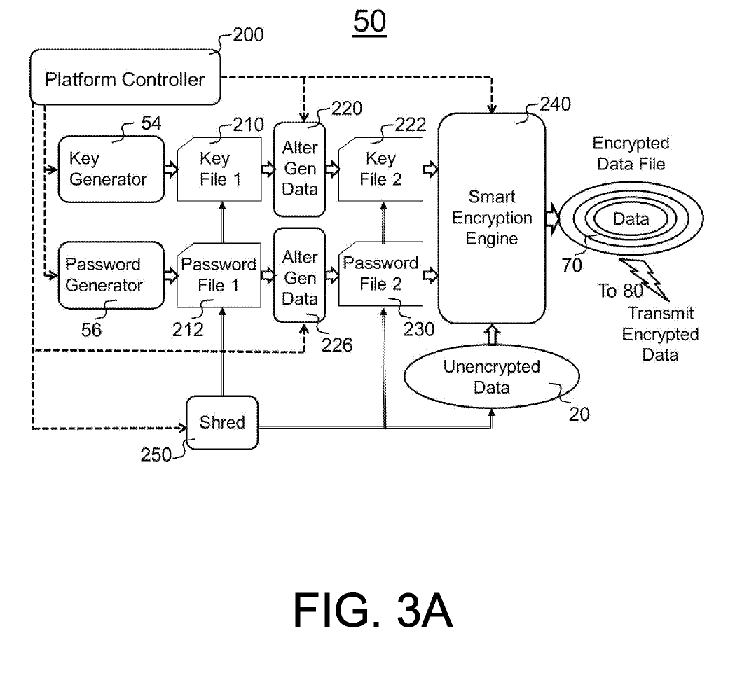

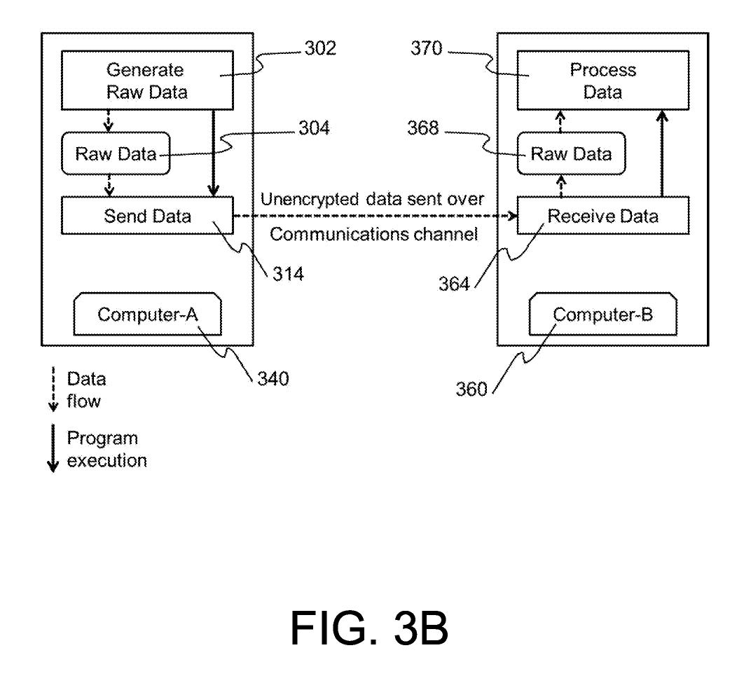

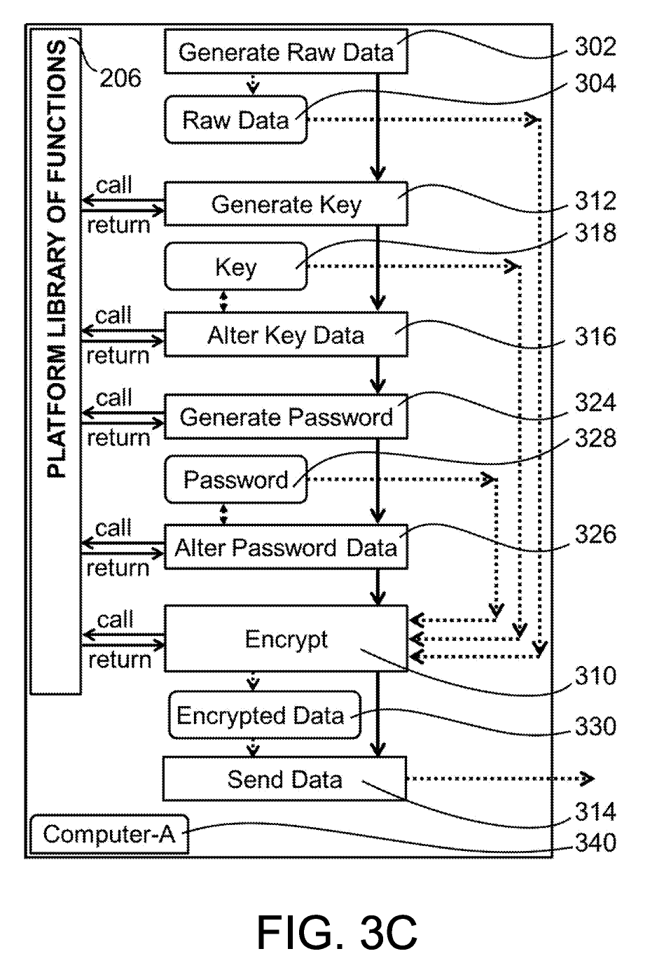

In accordance with the present subject matter, the scripted or programmed platform controller library 200 is provided. FIG. 3 consists of FIGS. 3A, 3B and 3C. FIG. 3A is a detailed block diagram of the encryption module 50 of FIG. 2 illustrating the scriptable platform controller 200 directing the steps of each encryption process. FIG. 3B demonstrates the system before the platform security has been added, and FIG. 3C demonstrates processes and data flow after the platform has been added.

The codes may also allow for embodying processing instructions so that data may be sent to the Cloud and processed in the Cloud behind the decryption platform.

In the present description, “switch” refers to an option and parameter on a command line of code in a script. The particular command is denoted by -(letter), where (letter) is a particular alphabetical character specifying a corresponding value. Switches include:
-f or -F, each of which specifies a file with commands to run. The -F switch specifies an encrypted command file;
-c, which specifies a tag number and an associated CSV file by name;
-C, same as -c except the CSV file is encrypted and is decrypted directly to memory;
-t, which specifies the name of a table file;
-T, same as -t except the table file is encrypted and is decrypted directly to memory;
-w switch is used to cause each script command to run for every record in the CSV data source with the specified tag number. A simple field substitution, for example, $3$, would be replaced by the third field in each record of a CSV file;
-z command line switch;
-x command line switch to specify Password;
-s and -f specify start and finish bytes of Key;
-k command line switch to specify Key File; and
-p command line switch to specify Password File.

In FIG. 3A, the scriptable platform controller 200 provides a selected seed packet 400 (FIG. 5) to the key generator 54. The key generator 54 processes the seed to produce a first key file 210. The first key file 210 contains an encryption key for -k switch. Similarly, the scriptable platform controller 200 provides the selected seed packet 400 to the password generator 56. The password generator 56 utilizes the current algorithm and provides a password to a first password file 212. The password file contains an encryption password. The password file name follows the -p switch.

For further unpredictability, the output of the first key file 210 is provided to a key algorithmic alteration generator 220 which “unpredictably” modifies the specified key to a second key file 222. The key algorithmic generators 220 and 226 are each an algorithmic transform which takes random data from a key file or a password file and modifies the data so it is different. The control of this change is communicated by a side channel. The side channel is a link other than the channel used to send the encrypted results. The side channel could be, for example, a telephone link or text message or information made available on a website or by prior agreement or by any other means. A purpose of this is to defeat an insider attack wherein the insider does not know what side channel is chosen or when the change control signals are transmitted or what the contents are.

Similarly, the password file 212 provides a password to a password algorithmic alteration generator 226 which provides a new password to altered password file 230. The second key file 222 and the second password file 230 provide a key and a password to a smart encryption engine 240. The data module 20 provides unencrypted data to the smart encryption engine 240. The smart encryption engine 240 provides encrypted data to the encrypted data file 70. The encrypted data is forwarded to the network 80 for transmission as illustrated in FIG. 2.

After this operation is performed, both the key file contents and the password file contents are provided to a shred unit 250. After a critical file, such as a SeedFile and/or PasswordFile is created and used, it is shredded by another program so no trace of it remains. A five-pass overwrite is one suitable form of shredding. The path to each critical file and the name of each critical file should be randomly generated. The path of directories should be removed after the file is shredded.

As seen in FIG. 3A, the scriptable or programmable platform controller 200 utilizes a program defining individual, unique encryption processes. As illustrated in FIG. 3B the system is shown before it has been secured with the encryption platform. Communication is between a first computer 340 and a second computer 360. Common reference numerals indicate items corresponding to those in FIG. 3C. Also, the system in FIG. 3B comprises a receive operation 364, raw data collection operation 368, and a data processing operation 370.

FIG. 3C shows a system after it has been secured with the encryption platform. In one form, a set of APIs is provided including a library of functions 206 is made available to system. The functions are called by the algorithm steps (302, 304, 312, 318, 316, 324, 328, 326, 310, 330, and 314). These steps can optionally use changeable encrypted data files to dynamically alter its behavior “unpredictably” to others. The algorithm steps can be implemented in a script or a program. The security functions are called directly in to the platform library of functions 206.

In the scripted version, “switch” refers to a command line option in a program invocation. In the scripted version of the platform, a command option is denoted by -(letter), where (letter) is a particular alphabetical character sometimes followed by an associated value.

A next step is creation of files which determine security behavior. These files include command files, table files, and comma-separated values (CSV) files, which can themselves be encrypted with yet a different key and password. The functions to use these files are found in the library of functions 206. The program allows a user to decrypt and search the text data on demand and edit in memory without exposing unencrypted data. This is an example of secure data-in-use or data-in-change.

Processing is illustrated in FIG. 3C. FIG. 3C illustrates a method, flowchart, and a non-transitory digital program. Components referred to in FIG. 3C are illustrated in FIG. 3A. At block 302 raw data is received. Raw data may come from a source such as the electric meter 14 of FIG. 1. At block 304, raw data is transmitted to the encryption process 310. Raw data is also transferred to the key generation process 312. The key generation process 312 issues a call to the platform library of functions 206 and receives a process for the key generation performed in key generator 54. The key generation process 312 provides the value to the first key file 210. At block 316, the value from the first key file 210 is supplied to the algorithmic transform operator 220 to produce an output in the second key file 222. At block 318, the key value is transmitted from the second key file 222 to the encryption process 310.

Password generation is performed at block 324. At block 324, a value is provided to the first password file 212 (FIG. 3A). This value is provided to the algorithmic transform operator 226 to produce an output which will be coupled to the second password file 230. The password value is provided to the second password file 230 at block 326. At block 328 output of the altered password file 230 is provided to the encryption operation 310.

At block 310 the encryption operation is performed and at block 330 encrypted data is sent to the encrypted data file 70. At block 314, encrypted data is sent from the encrypted data file 70 to the network 80.

There are four possible scriptable controller command file script lines. The first is a comment, which has an asterisk, ‘*’, in column 1. The second possible script line is a blank line, consisting of just an EOL (End Of Line) with possible SPace and/or TAB characters.

The third is #include “cmnd_file_name,” which will cause the contents of that named command file to be inserted at this point. There are two limits on #includes. It is a fatal error if #include is more than 5 deep, as this prevents accidental circular #include loops. It is also a fatal error if there are more than 50 #includes in any given command file. Note that if the top level command file is encrypted then all included command files must also be encrypted with the same random data sequence.

The fourth is a command. A command is a program name followed by its switches and parameters to run, with or without substitutions, for example Shred_WIN -b KeyFile.

A table file is read by the scripted platform controller 200 using a -t command line switch, or the -T command line switch for ASBE encrypted table files which are decrypted directly to memory. There can be 0, 1, or more tables. The purpose of a table file is to provide data for the scripted platform controller 200 to use to make decisions, or directly be used as parameters, or as part of a calculation for command parameters for a command within a script file given with a -f or a -F command line switch.

Encrypted or plain text table files are also readable by built-in functions such as table_read_file( ) or table_read_file_ez( ).

The purpose of a CSV file is to provide records of data with a number of fields, a two dimensional array of fields, for the scripted platform controller 200 to use in conjunction with commands listed in the command file script read with the -f or -F command line switch directly as a parameter for a program, as a parameter for a calculation, to make decisions, or virtually any other purpose.

A CSV file is read by the scripted platform controller 200 using a -c or a -C command line switch for ASBE encrypted CSV files which are decrypted directly to memory. There can be 0, 1, or more CSV files. A CSV file can be in the form of a spreadsheet, the result of database query, written by any other program, received as an encrypted file and then be decrypted for use, or manually created with a text editor.

The data in a CSV file can be accessed using the CSV Functions. When combined with the -w command line switch, the scripted platform controller 200 will repeat the commands for each record in the CSV file with the tag number specified as the parameter of -w and make a CSV field substitution. Every field of a CSV file, is of type s, and can be converted to other types as needed, by a type conversion function, for example, $add_i(5, s2i($3$))$. Note that only comma separated fields are supported in a CSV file read by the scripted platform controller 200. A CSV file that is tab separated would look like it has only one field.

The extensive choice and flexibility for dynamic scripting, of algorithmic parameter calculation, that is unpredictable to others using built-in security functions, exponentially increases security. These steps consist of creating and executing command line invocations of encryption engine 240 and other system programs.

For added security, the script which runs programs, after calculating parameters for each program to run, can itself be encrypted. Similarly, data input files, i.e., CSV files and table files, can be encrypted. There is much choice and flexibility on what these steps are. These steps comprise creating and executing command line invocations of encryption engine programs and other system programs. These command lines may be written to a scripting file which is executed or they may be executed directly by making the appropriate call to the system that is running all these programs. The platform controller script is executed once, or may be executed for each record in a CSV file by using a -w switch in the program script.

A switch is a sequence of characters on a command line which will provide an input to a program automatically. This is done in the alternative to using a graphical user interface (GUI) for providing inputs, so that the whole process can be automated.

FIG. 4 is a block diagram illustrating cooperation between the encryption module 50 and the decryption module 90. The arrangement of FIG. 4 provides a pair of collaborating M2M computer nodes that automate all program parameter calculations through scripting or programming during an end-to-end encryption and decryption process. The source process 16 provides unencrypted data to the data module 20. The data module 20 provides data which is encrypted by the smart encryption engine 240. The smart encryption engine 240 provides encrypted data to the encrypted data file 70. The encrypted data file 70 is coupled via the network 80 to the decryption module 90. The decryption model 90 comprises an encrypted data file 110 providing data to a smart encryption engine 260. The construction of the smart encryption engine 260 may be identical to that of the smart encryption engine 240. The smart encryption engine 260 delivers data to a decrypted data file 270. The decrypted data is utilized at the facility 1 by a destination process 280.

The extensive choice and flexibility for dynamic scripting or programming of algorithmic parameter calculations using changeable external data files exponentially increases security. This makes the calculation unpredictable to others. These steps consist of creating and executing command line invocations of, or calls to the functions of, the smart encryption engine 240 and other system programs or functions. For added security, the script which runs programs, after calculating parameters for each program to run, can itself be encrypted. Similarly, data input files including CSV files and table files can be encrypted.

There is much choice and flexibility on what these steps are. These steps consist of creating and executing command line invocations of smart encryption engine 240 programs and other system programs, or calls to the platform library of functions, and other system functions. These command lines may be written to a scripting file which is executed or they may be executed directly by making the appropriate call to the system that is running all these programs. The script is executed once, or may be executed for each record in a CSV file.

The smart encryption engine 240 is told what to do in a script by using exactly one instance of either command line switch -f or -F, each of which specifies a file with commands to run. The -F switch specifies an encrypted command file. These commands can contain macro-like sequences, or substitutions, between two $ which are replaced according to a set of rules of the scripting Language before the command is issued to the operating system.

The smart encryption engine 240 program is told what external data to use, by the use of one or more instances of command line switches:
-c, which specifies a tag number and an associated CSV file by name;
-C, same as -c except the CSV file is encrypted and is decrypted directly to memory;
-t, which specifies the name of a table file; and
-T, same as -t except the table file is encrypted and is decrypted directly to memory.
   If the -w switch is used, then each script command is run for every record in the CSV data source with the specified tag number. A simple field substitution, for example, $3$, would be replaced by the third field in each record of a CSV file.

The many unique features of the scripted platform controller 200 include a recursive application programming scripting language for scripting, or a simple API for direct inclusion in application and system libraries.

Built-in functions support multi-factor e.g., >10, for authentication. The script and data files, i.e., the CSV and table files, can be ASBE encrypted. Data parameters are extracted and used from CSV files or simple, indexable table files of different types, e.g., integer or string. Use of command files using time and other random but deterministic factors make the scripting of parameters unpredictable to those who should not have access or control.

Command files use a macro-like substitution syntax with large and growing built-in function libraries. Command file executions can be automatically repeated for every record of a specified CSV file, i.e., -w switch. The built-in function library contains powerful security and decision functions to facilitate scripting. These include array functions, block functions, control functions with flow control and looping ability, encryption functions, and name-value functions.

Other scripting language may be implemented using code written in a standard programming language such as C or C++ and interfaced to the present API and static libraries 206 (FIG. 3C). In one form the API and static libraries 206 comprise over 400 functions. Scriptable command files may comprise plain text using the -f switch or encrypted text using the -F switch. In one form the static library 206 comprises over 100 built-in functions, with over 300 other functions available directly in C.

FIGS. 5, 6, and 7 illustrate the seed packet structure and seed structure used in generating random data streams.

FIG. 5 is a diagram of the structure of one example of a seed packet 400. A seed packet 400 is a data structure of data comprised of multiple data sets. The seed packet comprises a set of multiple encryption parameters. The encryption parameters are used one at a time by senders and receivers of encrypted data. These data sets include a seed offset table 404 including seed offset table entries 406 and also includes a seed table 408 comprising seeds 410. A seed 410 is an initial state or part of an initial state of a random data or a random number generator. A numerical value of the seed 410 could be time. The value could come from a side channel. The value could be chosen from a list that could be included in a seed number or a token 460 (FIG. 7).

The entries in the seed packet offset table 404 can be relative to the table entry, the beginning of the table, the beginning of the seed packet, the end of the seed packet, or any other implicitly or explicitly known starting point.

A seed packet 400 comprises a number, NS, of seeds 410. The seeds 410 in FIG. 5 are numbered from 410-0 through 410-(NS−1). Each data set, or seed, is used algorithmically to generate a sequence of random data. One form of seed packet may comprise a changeable algorithm which utilizes one or more seeds to both generate and make use of an encryption key and password.

A seed packet 400 can be replaced in its entirety, or an individual seed 410 in the seed packet 400 can be changed. Any change to a seed packet 400 can be made by a person performing administrative tasks for the platform. Any change to a seed packet 400 is synchronized by all senders and receivers of encrypted data to switch to the changed. The synchronization can occur at a specified time or by any other event known by all senders and receivers. Which event and how that event is communicated is itself subject to change and is a choice inherent to the platform controller and program 200.

Which seed is used within the seed packet for any given encryption or decryption, can be chosen by the platform or real-time choice by a user. Various methods for selecting a seed 410 that is unpredictable to attackers include, but are not limited, to prior agreement, a person using a GUI to select a seed number from the range 410-0 to 410-(NS−1), a random process, or an algorithmic process.

The selected seed 410 can be chosen implicitly by all senders and receivers. Alternatively, it may be known by sending a seed token 460 (FIG. 7) comprising a number of a known length of bits which is algorithmically associated with a particular seed 410. How this seed token 460 is communicated can vary over time and can use the same or a different communications channel, or channels, used to convey the encrypted data. Another arbitrarily chosen means known to, or communicated to, both sending and receiving platforms could be used in the alternative.

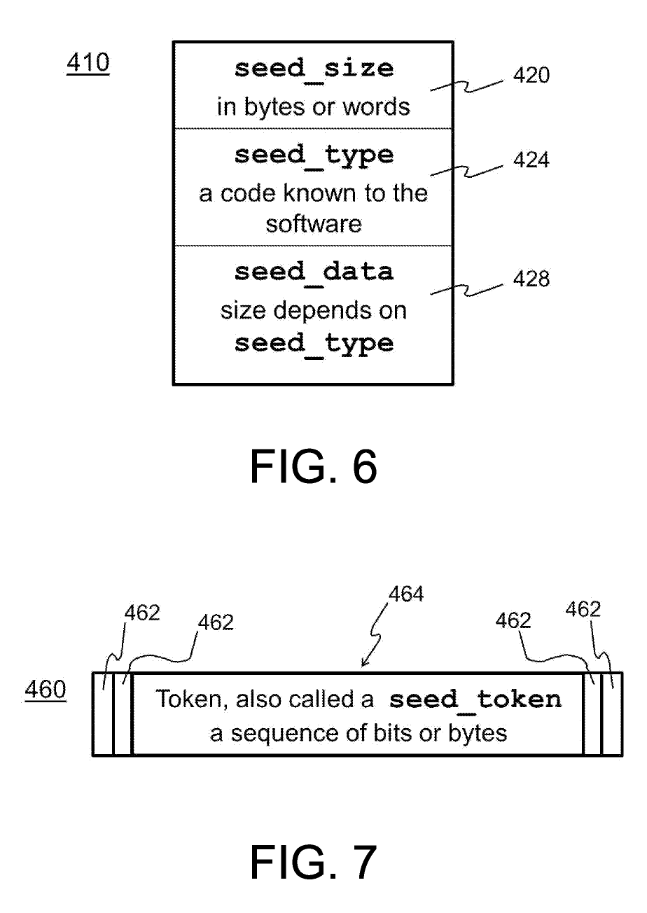

FIG. 6 is a diagram of one example of a data structure of a seed 410 within a seed packet. Each seed 410 is a data structure of many forms, known to the software that utilizes the seed 410. Common contents for a seed data structure include seed size 420, seed type 424, and seed data 428.

The exact structure of a seed 410 is known to the software. The seed data 428 can be organized as a sequence that is interpreted as an array of values of the same type and size, a sequence of values of different type and size, a tree, or recursively as any combination. Recursion is a method where the solution to a problem depends on solutions to smaller instances of the same problem as opposed to iteration. Most computer programming languages support recursion by allowing a function to call itself within the program text. Some functional programming languages do not define any looping constructs but rely solely on recursion to repeatedly call code.

FIG. 7 is an illustration of a seed token 460 that may be used. In order to authorize a particular set of users to interact with one another, a token is provided to each user in the set to enable response to the dynamic scripting. The token is preferably sent to the authorized users over a communication channel other than the data channel. The token enables authorized users to use the same variable factors for decryption and authentication. The random data generated by a particular token changes if the associated seed packet changes.

In the present description, the terms token and seed token are used interchangeably. A token is an arbitrary number of characters in a sequence whose meaning is only known to the sender's and receiver's encryption/decryption software. The token allows them to generate a key within a file and a password in a file or to generate a key and a password in memory. The token algorithmically causes data to be chosen and algorithmically manipulated in a way which typically uses a data table to impose a changeable, arbitrary mathematical step. Mathematical steps include such options as random data generation and transforms of that data and selection of bytes within a file, or any other details of the communications between computer nodes.

The seed token 460 comprises a sequence 464 of data bits 462 whose size is either implicitly known or whose size and contents are self-described by the particular order and contents of bits or bytes in the seed token 460. The seed token 460 is associated with a particular seed 410.

Each seed 410 can optionally contain a code number which specifies which algorithm, or algorithmic variation, is applicable for that individual seed 410. The meaning, or interpretation, of this code number is subject to change at any time by updating the software or data tables.

Each seed packet 400 or individual seed 410 can itself be encrypted by another encryption key only known to the program or software algorithmically utilizing it. The platform 50 selects a seed 410 from within the seed packet 400. Alternatively, the seed 410 is selected by a user.

A seed packet 400 can be replaced in its entirety, or an individual seed 410 in the seed packet 400 can be changed. Any change to a seed packet 400 can be made by a person performing administrative tasks for the platform 50. Any change to a seed packet 400 is synchronized by all senders and receivers of encrypted data 70 (FIG. 2). The time or event used for synchronization may correspond to a clock time or an event (such as a message of specific type). The platform accordingly may select which event is used and how that event is made known to users.

Identification of the selected seed 410 can be supplied by sending a seed token 460. The seed token 460 comprises a known length of bits 462. The particular seed 410 which corresponds to the seed token 460 is determined by the encryption algorithm.

The seed packet 400 available to the software embodying the changeable algorithm may be built into a program, contained in hardware memory, stored in a file or a combination of these.

An embedded platform 50 may be a scripted or programmable platform which comprises a set of programs. The script running the scriptable platform controller 200 can itself be encrypted and decrypted in memory. One form of algorithm used by the platform 50 can be a scriptable controller 200 for invoking the unique functionality of special purpose hardware and software to run programs which will securely control the system, produce and send, or receive and utilize data. Each node in this scriptable controller needs to be customized for what unique functionality it performs, what data source or destination it uses, what and how many data files or messages it needs, how and when these data files or messages are communicated between one or more other system nodes, and how to handle alerts.

The purpose of this scriptable or programmable platform controller 200 is to automate dynamically parameterized activity with scriptable algorithms in a system. The controller 200 is used to control a system, generate, request, or use data, process data, make database queries or changes, make software updates, collect status and usage information, send or receive and process alerts, encrypt or decrypt data. The scriptable platform controller 200 is also used to run a program to send or receive encrypted data, scripts, programs, status, alerts, or software updates.

Alternatively, an embedded scriptable or programmable platform controller 200 may be provided which comprises a set of APIs and static software libraries. These static libraries can work on either files or data in memory. When encrypting or decrypting with the embedded scriptable platform controller 200 an encryption key and password, input data, or output data can be independently located in a file or in memory.

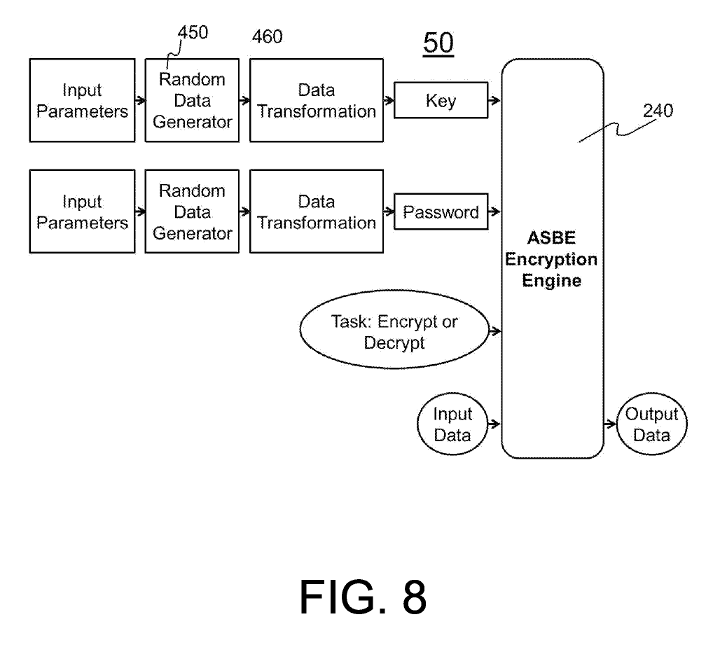

FIG. 8 is a block diagram of a platform 50 comprising a random data generator 450 and a smart encryption engine 240. A random data sequence 460 is generated by the random data generator 450. One manner of generating the random data sequence 460 is disclosed in commonly invented, U.S. Pat. No. 8,995,659, the disclosure of which is incorporated herein in its entirety.

Each generated random data sequence 460 created may be used in its entirety or may contain a sub-sequence of the random data sequence 460 incorporating the encryption key or the encryption password. The length of the sub-sequence of data is specified directly or indirectly, i.e., algorithmically, by data within the seed 410 (FIG. 6). The algorithmic process used to generate keys or passwords may be used to vary the sub-sequence. The algorithmic process steps are themselves subject to change. Replacing the software in whole or in part or changing a data table used by the software changes the algorithmic process steps. The software update or the data table can optionally be encrypted itself by another encryption key only known to the encryption system, also called the platform 50.

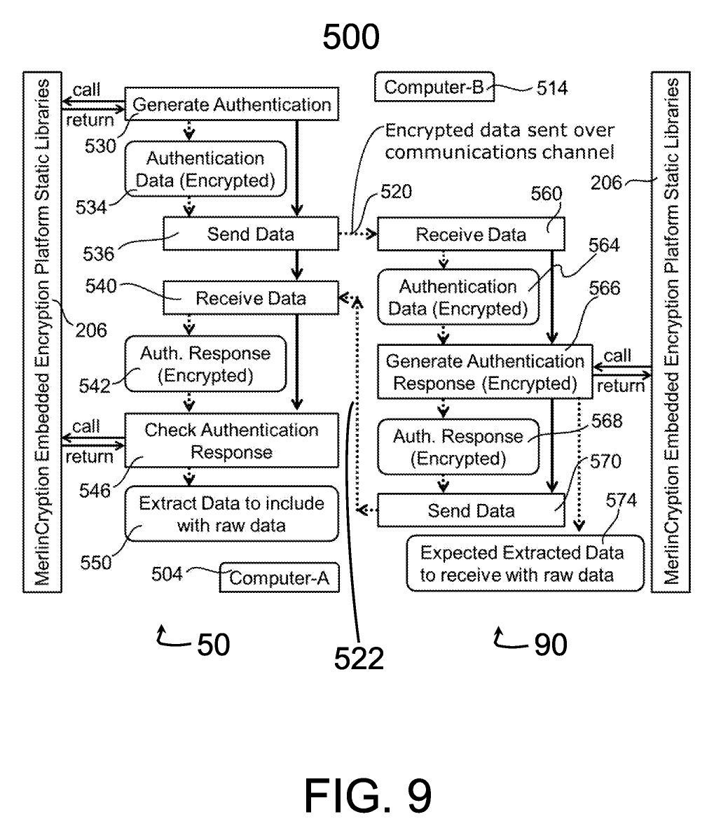

FIG. 9 illustrates a generalized authentication scheme 500. The first encryption platform 50 (FIG. 4) cooperates with a first computer 504 at a first communications node 506. The second encryption platform 90 cooperates with a second computer 514 in a second communications node 516. Encrypted data is sent from the first computer 504 to the second computer 514 via a first communications channel 520. Encrypted data is sent from the second computer 514 to the first computer 504 via a second communications channel 522. The first communications channel 520 and the second communications channel 522 may optionally comprise the same communications channel.

At block 530 an authentication process is called and the process is provided from the library of functions 206. Encrypted authentication data is provided at block 534 to a second data operation 536. Encrypted data is sent to the second encryption platform 90 over the first communications channel 520. The first encryption platform 50 receives encrypted data from the second encryption platform 90 over the second communications channel 522 at block 540. At block 542, the authentication response is received and forwarded to a “check authentication response” operation at block 546. A program is called from the static library 206 to determine if the authentication response is valid. If it is valid, at block 550 data from the encrypted communication is extracted and sent to the destination process 280 (FIG. 4).

At block 560, the second encryption platform 90 receives encrypted data from the first communication channel 520. The encrypted authentication data is coupled at block 564 to the authentication generation operation 566. The authentication generation operation calls an authentication routine from the static library 206 of the second encryption module 90. The authentication response operation determines whether the authentication response is valid at block 568. At block 570, data is sent from the second encryption module 90 over the second communications channel 522 if the authentication response was valid. At block 574, extracted data is received. Extracted data from a validated authentication can optionally be added to any data message to enable the receiving computer to process the message. If valid authentication is not present the message would be ignored and discarded.

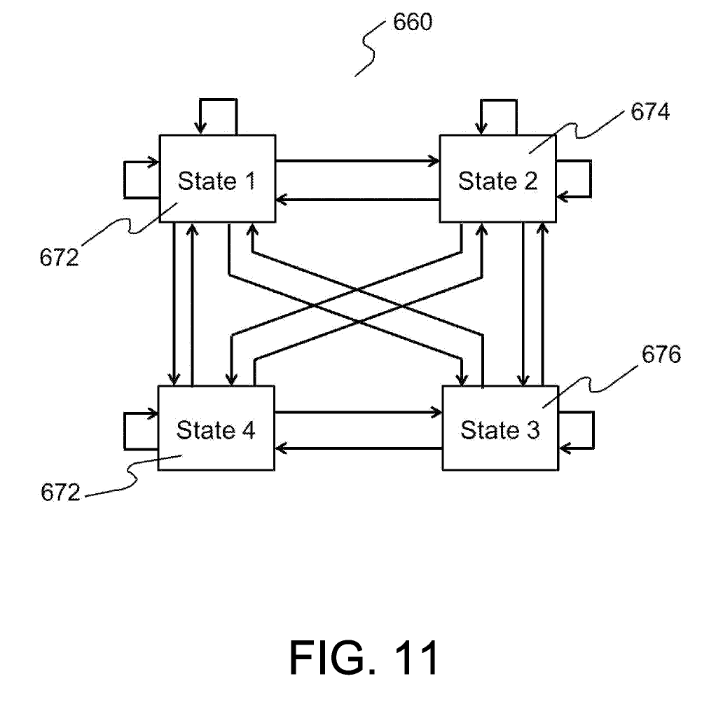

The authentication inputs may comprise either textual noun name style format or random selected variables. Response to the authentication inputs comprises a state machine 660 (FIG. 11) defining transitions of states in response to each input. Authentication inputs are embedded in noise. Authentication may include querying a sending device as to its IP address or CPU serial number, for example.

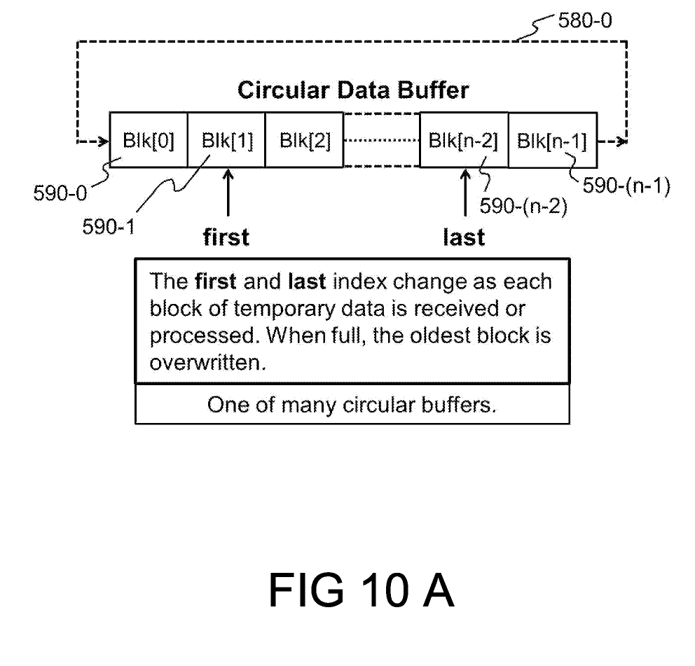

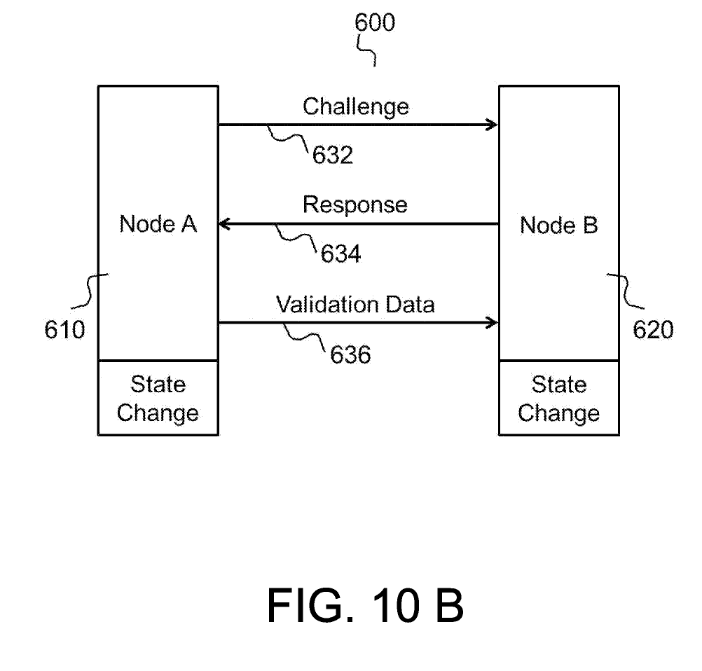

FIG. 10, consisting of FIGS. 10A and 10B, illustrate examples of more than one form of authentication that may be used. A number of different software methods can be used. Categories of authentication factors include temporary data. Another category is known data. Known data may include user ID and password plus challenge-answer questions. Unique system data may be used. This comprises such identifiers as a system-ID, IP address, phone number, disk serial number, switch settings, ROM contents, software and OS version or other such data. An alternative category is physically processed data.

FIG. 10A illustrates authentication using temporary data authentication. A circular data buffer 580 is provided. In one preferred embodiment, many circular data buffers 580 are provided, one for each of a number of locations. Therefore, the circular data buffer 580 in FIG. 10A is labeled 580-0. M circular data buffers 580 are provided, where M is an integer. The circular data buffers 580 may be referred to as 580-0 through 580-(M−1). Each circular data buffer 580 comprises locations 590 numbered 590-0 through 590-(n−1), where n is the number of locations. Each location holds a respective data block. Preferably many circular data buffers 580 are provided, each having a plurality of data locations 590. In this particular arrangement, locations 590-1 through 590-(n−2) are first and last index locations. The first and last indices change as each block of temporary data is received. When the circular data buffer 580 is full, the oldest block is overwritten.

FIG. 10B illustrates an authentication routine 600 wherein the factors include challenge-response questions. People accessing a machine need to be authenticated, and machines automatically communicating with each other need to authenticate each other. Authentication normally uses factors which are: Known, Physically Possessed, or Unique. To these three, the scripted platform controller 200 adds factors from the static library 206 which are Temporary or Transient. These authentication factors serve to identify both people and machines. The use of a high number of factors, e.g., >10, enables stochastic authentication.

The present subject matter enables authentication that is quite formidable in contrast to using only user ID and password authentication. Authentication that is unpredictable is enabled.

In the present system, some or all of a number of factors can be used. These include:

a number or string sent in a text message, voice message, or email;

a link in an email;

an answer to one or more previously established security questions;

identifying a color, or an image, or hard to read text, e.g., Captcha; and

clicking on one of many buttons or a sequence of buttons, identified by: name, number, color or image as specified in a text widget.

When a person comes to service, or access, a remote machine they may be required to have a special physical key, or utilize other factors, which allows them to make changes to, or access, that machine.

Some of the above additional authentications factors are usually required in response to a “difference.” Differences may include the first time a new user accesses a secure system, access from a previously unknown computer, e.g., one having a different MAC address or some other machine specific set of parameters, access at an untypical time of day, or an IP address geographically different than usual.

Each machine needs to authenticate itself to other machines before data communications can be accepted and acted upon. For authentication, both fixed and time varying authentication factors are sent in encrypted form. Authentication may be made where multiple parameters for decryption are synchronized by prior agreed upon events or known facts, such as time, e.g., a day or month, a token such as a number or short string, or unique factors known about each of the two communicating machines such as MAC address or machine ID number.

Further criteria for authentication include:

contents of one or more previously sent messages;

algorithmically agreed on random factors;

algorithmically altered time of additional clock not set to correct time;

unique factors known about each of the two communicating machines such as version of OS or other software; number, size of hard drives, MAC address, or machine ID number;

hash (such as, but not limited to MD5 or SHA) of generated or previously sent or installed message or file;

algorithmically altered GPS coordinates;

sending a short, periodic “heart beat” message, e.g., every minute or 10, where the absence of one makes that machine be distrusted until re-authorized. The contents of this heart beat message can be constant or follow an algorithmic sequence of states; or

responding or communicating on another communications channel, such as a wireless or land line phone or over the power line.

Note that many of the people and machine authentication factors listed above are themselves multiple factors. The above lists are exemplary and in no way limiting.

In FIG. 10B a first node 610 and a second node 620 are provided. Each node represents an interface at which software is coupling data from one node to a secure node. The first node 610 cooperates with the second node 620 to verify knowledge of known factors such as user id and password plus challenge-answer questions. The first node 610 can issue a challenge 632. The second node 620 provides a response 634. If correct, the first node 610 issues validation data 636. In this manner a known factor can be physically possessed by a node.

A node can also be identified by unique characteristics such as System-ID, IP address, phone number, disk serial number, switch settings, ROM contents, software and OS version. These characteristics may be used in the alternative to the known data.

FIG. 11 is a block diagram illustrating the use of validated and other system data to control transitions of a state machine 660. The state machine 660 indicates an initial state or record of something, e.g., a register stored someplace. In the present illustration transitions may be made between a first state 672, a second state 674, a third state 676, and a fourth state 678. The state machine 660 defines a set of possible input events, a set of new states that may result from an input and a set of possible actions or output events that result from a new state. The arrows in FIG. 11 represent conditions which cause a transition from one state to a selected next state.

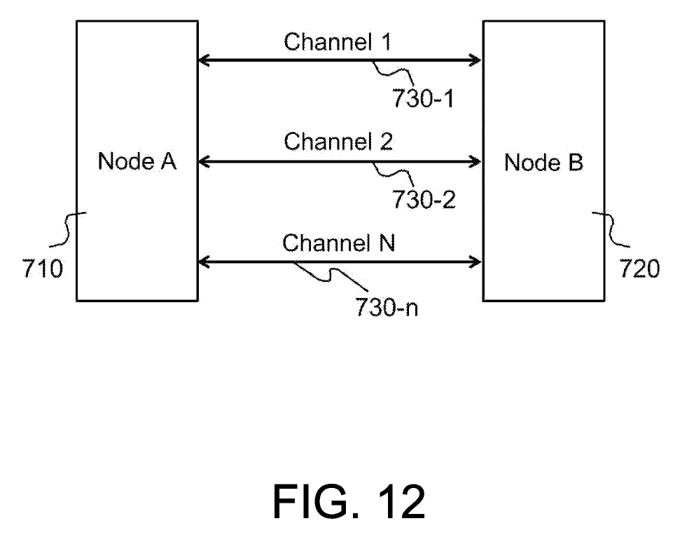

FIG. 12 is a block diagram of multiple communications channels between communications nodes. In FIG. 12 communications channels are coupled between a first communications node 710 and a second communications node 720. Communication channels 730-1 through 730-n are provided, where n is the total number of channels. Different types of channels may be utilized. Types of channels may include transmission control protocol/internet protocol (TCP/IP) networks, digital or packet radio, spread spectrum digital radio, and telephone channels. Telephone lines can comprise land lines, VoIP, or wireless. A modem or dual tone multi frequency (DTMF) hardware for data transmission may be used.

Encryption is preferably used on all communications between a remote system and a command-and-control center, a server and client, and computer nodes on the Cloud.

One technique used for a number of functions in the encryption platform 50 is name-value association. Name-value data is in the form of a name followed by a value embedded in pseudo random data. There are functions to create such files or data strings and to extract a value given to a name. This name-value association feature is used for such steps as authentication and for data transformations or algorithmic control of the pseudo random data generation of encryption key and password, or for any other purpose such as status, alerts, or tokens.

Both forms of the encryption engine 240 can utilize files, or data in memory, to dynamically alter system algorithmic behavior. This alteration is unpredictable to attackers. These files or data are in one of two forms. A first form is tables or arrays of one of different types, e.g., such as bytes, integer, double strings, or hex strings. Another form comprises CSV. CSV records are each organized as a number of fields. Each field is treated as a string of characters which can be converted from a string to another supported type.

In a table translation approach, processor-generated memory accesses require address translations before the access to the memory is completed.

In one preferred form, unpredictability is strengthened by renaming programs in the encryption platform 50 to a name only known to the security staff. For example, the file platform_controller.exe can be renamed to hearts.exe, the file flexible_encryption.exe can be renamed to firefox.exe, and so on. In this way when these programs execute, their name is unknown to a human or digital observer. In the script, log files are renamed with an -L switch so that the default file name is not used.

This processing of data-at-rest, data-in-motion, data-in-use, and data-in-change, typically takes place on more than one computer, server, or embedded system in a distributed or M2M environment. The encryption and decryption takes place over small or large expanses of time and network, communications, and physical space, and can involve one or multiple different functional sub-systems which need to communicate securely using strong encryption.

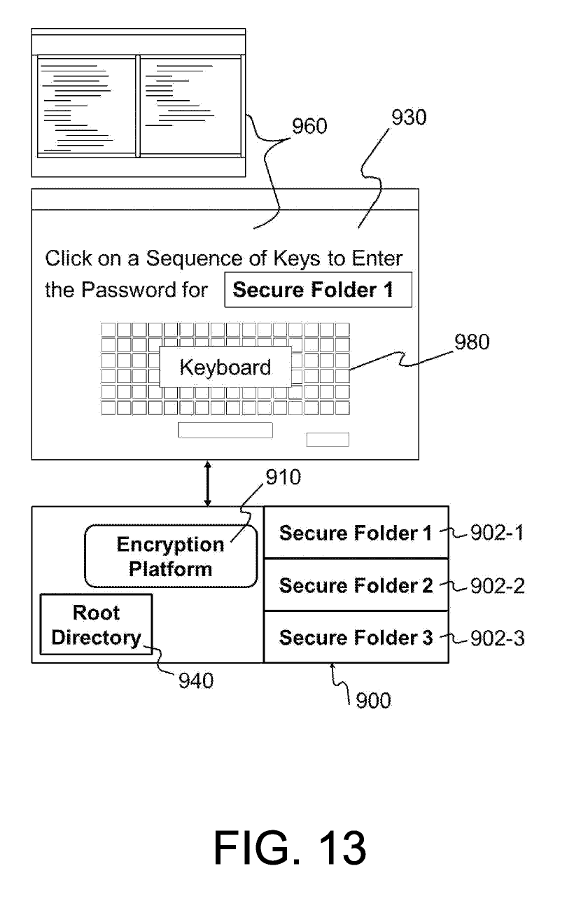

FIG. 13 illustrates an encryption system in which an encryption platform such as the encryption platform 50 may be used to secure data in a portable storage device. In the present embodiment, the portable storage device comprises a USB flash drive 900. A plurality of secure folders are provided. In the present illustration, secure folders 902-1, 902-2, and 902-3, collectively referred to as secure folders 902, are provided. An encryption platform 910 is provided which may deliver encrypted data to each of the secure folders 902. The encryption platform 910 is used to provide separate encryption with separate passwords and keys for each of the secure folders 902. The encryption platform 910 provides for ASBE-encrypted data storage areas for securing sensitive data from unauthorized access.

The flash drive 900 cooperates with a program 930. The program interacts with a root directory 940, i.e., the first or top-most directory in the file folder hierarchy, in the storage device 900. From the USB root directory 940, the program 930 is initiated to create and enter a password for access to the secure folders 902. The program interface 960 opens automatically selected secure folder 902 A program interface 960 provides a display. Files to be encrypted are shown in one column. They may be dragged into another column for encryption. The files are automatically protected with ASBE encryption when dragged into the encryption column in the program interface 960. The encrypted files receive an appended file extension .ASBE to provide visual confirmation of encryption. In the computer's file explorer window, the root directory 940 also displays an icon for the encryption program 930.

For increased security, a virtual keyboard 980 is provided within the program interface 960. The virtual keyboard 980 has separate virtual keys for each standard special character of a “QWERTY” typewriter layout, uppercase letters, lowercase letters, and punctuations. In this manner, entries may be made within the program 930. It is not necessary to use a physical keyboard which sends signals through a path that could possibly be intercepted by a key stroke logger.

For optimal security, any encrypted file in the USB flash drive 900 can be securely erased. A “delete securely” command causes overwriting of every byte and may use varying security standards such as overwriting five times before deletion.

The program 930 may also provide a mechanism so that after a preselected number of invalid virtual password entry attempts, an unauthorized attempt at access is inferred. In response to the unauthorized attempt, the particular secure folder 902 and its password are deleted.

The present subject matter provides for a continuously varying set of keys, passwords, and authentication criteria. A changeable algorithm utilizes one or more seeds to both generate and make use of an encryption key and password. A different seed may be provided to each group of users so that the same hardware will appear to be a different machine to each group. Different custom versions of the platform encryption engines are not interoperable with each other or with a standard version. Steps in the above processes may be performed in different orders where not logically impossible or where operation is changed. Using a changeable algorithm improves unpredictability of encryption. Consequently, speed-optimized massive quantity encryption is enabled.

A machine-to-machine (M2M) partner automates all program parameter calculations through scripting or programming during an end-to-end encryption and decryption process. A scriptable controller invokes the unique functionality of special purpose hardware and software to run programs which will securely control the system, produce and send, or receive and utilize data. Dynamic scripting or programmed calculation of the encryption parameters and automatic response to alarms and alerts or to protect data transfers is provided.

What is claimed is:

1. An algorithmically flexible multiple parameter encryption system in an embedded encryption platform, said multiple parameter encryption system comprising:
said embedded encryption platform comprising a set of programs, the set of programs being selected to define scripted or programmable operation;
said embedded encryption platform selectively configurable as a software development kit comprising a set of header files and static libraries corresponding to respective header files, the static libraries being compiled into a set of programs and providing access to functions via calls;
said embedded encryption platform being coupled to provide an authentication query to a remote user or computer and to receive an authentication response from the remote user or computer via a communications channel,
a state machine configured to be responsive to authentication responses in textual noun format or randomly selected variables in the authentication response and producing a state transition in correspondence with an authentication response;
said encryption platform being coupled to read a state transition of said state machine and to resolve validation of said authentication response; and
said encryption platform being switched in response to validation of said authentication response to enable communication of the remote user or computer with a local computer.

2. An algorithmically flexible multiple parameter embedded encryption platform system according to claim 1 wherein calls to the software development kit are provided whereby said embedded encryption platform is accessible in correspondence with a current set of encryption and system parameter values.

3. An algorithmically flexible multiple parameter embedded encryption system according to claim 2, wherein said algorithm comprises at least one non-constant stochastic authentication factors to calculate encryption parameters using a seed set from a data structure comprised of multiple data sets each used to algorithmically generate a sequence of random data coupled for generating and making use of an encryption key and password.

4. An algorithmically flexible multiple parameter embedded encryption system according to claim 3, wherein the program is configured and coupled to provide to a plurality of groups of users or computers a set of values to be used within the set of programs, each group of users or computers receiving a respective set of values.

5. An algorithmically flexible multiple parameter embedded encryption system according to claim 4, wherein said set of programs provides for condition-responsive expiration of encryption parameters.

6. An algorithmically flexible multiple parameter embedded encryption system according to claim 5, comprising at least first and second collaborating machine-to-machine computer nodes directing communications between the remote user or computer and the embedded encryption system in an end-to-end encryption and decryption process.

7. An algorithmically flexible multiple parameter encryption system in an embedded encryption platform, said multiple parameter encryption system comprising:
a platform library of changeable algorithmic functions;
a key generator performing a key generation process and providing a call to the platform library for generating a first value;
a transform module translating the first value and providing a key value;
a password generator performing a password generation process and providing a call to the platform library for generating a second value;
a transform module translating the second value and providing a password value;
a set of seed packets comprised of multiple data sets each used to algorithmically generate a sequence of random data coupled to said key generator and password generator for generating encryption keys and passwords.

8. An algorithmically flexible multiple parameter encryption system according to claim 7 wherein each seed packet contains a code number which specifies an algorithm to be called from said platform library.

9. An algorithmically flexible multiple parameter encryption system according to claim 8 wherein action in response to a code number is changed by updating data tables.

10. An algorithmically flexible multiple parameter encryption system according to claim 7 wherein a sub-sequence of a data structure is coupled to said key generator, the length of a sub-sequence of data being specified by an algorithm partially included within said embedded encryption platform and wherein said algorithm is further selectively distributed among at least one of the constructed scripts, calls to functions in static libraries in said embedded encryption platform and a target system.

11. An algorithmically flexible multiple parameter encryption system according to claim 10 wherein at least one seed is coupled to drive the changeable algorithm for generating and making use of an encryption key and password.

12. An algorithmically flexible multiple parameter encryption system according to claim 9 wherein a second encryption key is coupled for encrypting a software update or data table.

13. An algorithmically flexible multiple parameter encryption system according to claim 11 wherein the seed packet is a set of multiple encryption parameters which are used one at a time by a sender and by a receiver of encrypted data and wherein an initial and subsequent synchronizing command file is created and sent to synchronize the sender and the receiver of encrypted data, wherein commencement of use of new data is defined by a current algorithm.

14. An algorithmically flexible multiple parameter encryption system according to claim 7 wherein the platform comprises a software development kit having an application program interface.

15. An algorithmically flexible multiple parameter encryption system in an embedded encryption platform, said multiple parameter encryption system comprising:
an algorithm comprising selection of functions to synchronize event data of a sender and a receiver of encrypted data;
a key generator and a password generator;
a message system, selectively receiving and sending event data,
a processor changing the algorithm in the command file in response to preselected event data;
a data module being coupled to a plurality of transmission media; and
a coupling circuit responsive to algorithms to couple each user to said data module via a selected transmission medium.

16. An algorithmically flexible multiple parameter encryption system according to claim 15 wherein a preselected event comprises the end of a receiver having a need to receive encrypted data and wherein a change in the algorithm comprises removing authorization of the receiver.

17. An algorithmically flexible multiple parameter encryption system according to claim 16 comprising a time varying table including containing selectable validation criteria, wherein said command file accesses data to compare data from a receiver with expected criteria derived from algorithms and data tables to perform authentication.

18. An algorithmically flexible multiple parameter encryption system according to claim 17 wherein an event comprises a time varying signal.

19. An algorithmically flexible multiple parameter encryption system according to claim 17 comprising at least first and second collaborating machine to machine computer nodes directing communications between a remote user and the embedded encryption system in an end-to-end encryption and decryption process.
